(19) United States
(12) Patent Application Publication
(10) Pub. No.: US 2026/0219653 A1
(43) Pub. Date: Jul. 30, 2026

(54) PREDICTING OPERATIONAL DATA OF ASSET(S) OPERATING IN OPERATIONAL TECHNOLOGY NETWORK OF INDUSTRIAL CONTROL SYSTEMS

(71) Applicant: Honeywell International Inc., Charlotte, NC (US)

(72) Inventors: Arnab Bhattacharjee, Bangalore (IN); Dipanjan Saha, Bangalore (IN); Pratyush Swain, Sandur (IN); Nikhil Bansal, Bangalore (IN)

(21) Appl. No.: 19/040,876

(22) Filed: Jan. 30, 2025

(51) Int. Cl. G05B 19/418

(52) U.S. Cl. CPC G05B 19/4185; G05B 2219/31102; G05B 2219/33034

(57) ABSTRACT

Approaches for determining a variational limit(s) of an operating parameter of an asset(s) are described. In one example, values of a first operating parameter of an asset(s) operating in a first operating condition may be obtained. The asset(s) may be deployed in one of an architectural level of an operational technology network, associated with an industrial control system (ICS). The values may be processed based on a predefined criteria associated with the asset. In one example, the predefined criteria may define one of a performant operational state and a non-performant operational state of the asset(s) during the first operating condition. Further, a variational limit(s) for the first operating parameter may be determined, wherein the variational limit(s) may be indicative of a range of values of the first operating parameter of the asset(s) as the asset(s) operates during the first operating condition.

### BACKGROUND

A networked industrial environment may include a plurality of interconnected equipment, control systems, and processes which are typically deployed in manufacturing facilities, refineries, chemical plants, and other industrial settings. Such networked environments may further include industrial assets interconnected with each other to manufacture finished goods or products. Such industrial assets include a wide range of equipment, machinery, and systems used in manufacturing, processing, or production facilities to transform raw materials into finished products or provide essential services. Examples of such assets include chemical processing units, refining units, power generation units, manufacturing equipment, and material handling systems. To ensure optimal and efficient performance, such industrial assets may be monitored to check if the asset(s) under consideration is deviating from its otherwise performant operation. This may involve tracking various controllable variables and evaluating key performance indicators of the asset

### BRIEF DESCRIPTION OF FIGURES

Systems and/or methods, in accordance with examples of the present subject matter are now described and with reference to the accompanying figures, in which:

FIG. 1 illustrates system for determining a variational limit(s) of an operating parameter of an asset, as per an example;

FIG. 2 illustrates an environment of an industrial control system, as per an example;

FIG. 3 illustrates a system along with its functional components, wherein the system is for determining a variational limit, as per another example;

FIG. 4 illustrates an illustration for determining a variational limit, as per an example;

FIG. 5 illustrates an environment of an industrial control system, as per an example;

FIG. 6 illustrates a control system along with its functional components, wherein the control system is for training a prediction model, as per another example;

FIG. 7 illustrates a method for determining a variational limit(s) of an operating parameter of an asset, as per an example;

FIG. 8 illustrates a detailed method for determining a variational limit(s) of an operating parameter of an asset, as per an example;

FIG. 9 illustrates a method for training a prediction model, as per an example; and

FIG. 10 illustrates a system environment implementing a non-transitory computer readable medium for determining a variational limit(s) of an operating parameter of an asset, as per an example.

### DETAILED DESCRIPTION

Industrial control systems comprise of two networks—an operational technology network (OTN) also referred to as the process control network (PCN) and the informational technology network (ITN) or business network (BN). Industrial control systems generally rely on the OTNs to manage and monitor industrial asset(s) operating in an industrial process executing within the Industrial control systems. The OT network includes programmable control systems and/or devices that may interact with physical environments or may manage devices that interact with the physical environments. Such systems/devices detect or cause a direct change through the monitoring and/or control of devices, processes, and events. The control systems in turn may further include a collection of devices, systems, networks, and controls. Within the OT network is where most of the Distributed Control Systems (DCS), programmable logic controllers (PLCs), and/or field devices may be deployed.

OTNs generally include various architectural levels, each serving specific functions wherein a multitude of assets operate and generate operational data that may further be analyzed to provide crucial insights regarding performance of such asset(s). However, to effectively manage such asset(s), it is essential to continuously monitor and analyze the operational data of such industrial asset(s) operating under different operating conditions. This may involve the use of dedicated hardware and/or software for observing and identifying any changes to the operating parameters of the respective asset(s). Such dedicated hardware and software may also generate alarms and/or notifications through control systems when the asset(s) is working in a non-performant manner, which may help a user to identify and rectify any anomalies occurring in the industrial control systems. Also, in certain applications, alarms and/or notifications are generated based on an analysis of emerging patterns in the operational data of the asset(s) and in case of an abnormal behavior observed within the operational conditions of the asset(s), the same is reported to the user for deploying appropriate remedial solutions.

Generally, systems and/or devices which are also deployed for implementing extensive processing and calculations on individual or standalone (siloed) systems operating in the industrial control systems, wherein each siloed system and/or device may have local configuration parameters for operating under certain conditions. Siloed systems refer to a segregated storage and management of data within an organization, associated with the industrial control systems, often due to use of disparate systems, proprietary tools, security extensions, and operating systems that may not effectively communicate with each other. As may be known, siloed systems may use isolated sets of information held by different departments and/or teams working within the organization. Generally, vast organizations with numerous departments and/or teams may find it challenging to establish an easy and accessible communication channel, which may lead to isolated sets of information or ‘data silos’. A lack of proper communication and collaboration between different departments working independently to address individual data needs may result in data silos.

The conventional approach is to train a plurality of machine learning models with specific training data related to each of the siloed systems, with local configuration parameters and maintain individual disconnected models, for each outcome and/or calculation. There are numerous drawbacks associated with such conventional approaches. For instance, the conventional approaches for training the machine learning models may become invalid in case the local configuration parameters of the siloed systems are changed. Since the conventional approaches predict an outcome related to the local configuration parameters for which the model has been trained, it may become difficult for a user to trace an input lineage for the outcome (given by the trained machine learning model) since there are no predicted values available for the user to know that the outcome provided by the trained model (for each siloed system) is the predicted outcome.

Also, such conventional techniques may often exhibit limited adaptability to configuration changes, requiring frequent re-training when system parameters are modified. Also, the need for separate training models for each siloed system may increase computational and storage requirements, while also creating challenges in synchronizing the training data across functionally connected variables from different time periods.

Further, conventional approaches may often face increased latency issues in generating updated predictions when the local configuration parameters change along with scalability issues when dealing with a large number of inter-dependent variables and systems. For example, decision-making processes may be delayed, and the organization may be at a risk of missing valuable opportunities due to a lack of comprehensive insights. Strategic planning may also suffer due to siloed systems having siloed datasets, since concerned personnel associated with the organization may not reliably access and integrate data from the different departments.

Additionally, most of the local configuration parameters and/or history records related to the siloed systems are not maintained, which may lead to limited training data being available for training the machine learning models. Also, in a specific functional area of an enterprise, say a plant, all asset(s) are generally made to operate to fulfil a common functional goal.

Approaches for determining a variational limit(s) of an operating parameter of an asset(s) are described. In one example, values of a first operating parameter of an asset(s) operating in a first operating condition may be obtained. The asset(s) may be deployed in one of an architectural level of an operational technology network, associated with an industrial control system. The values may be processed based on a predefined criteria associated with the asset. In one example, the predefined criteria may define one of a performant operational state and a non-performant operational state of the asset(s) during the first operating condition. The predefined criteria may include, but is not limited to, one of a threshold value for the first operating parameter, a rate of change limit for the first operating parameter and a duration for the first operating parameter to remain operational within a specific range. Further, a variational limit(s) for the first operating parameter may be determined, wherein the variational limit(s) may be indicative of a range of values of the first operating parameter of the asset(s) as the asset(s) operates during the first operating condition.

Once the variational limit(s) is determined, the same may be transmitted to a control system hosted in an informational technology network within the industrial control system. In one example, the variational limit(s) may be utilized by the control system as an input to train a machine learning model. In one example, the machine learning model when trained may predict an outcome of an operation performed by the asset(s) operating within the operational technology network.

The present approaches offer several technical advantages for managing and optimizing industrial asset(s) in OTNs. For instance, by obtaining and processing values of operating parameters based on predefined criteria, the present approaches may be implemented to determine variational limits, reflecting performance of the asset(s) under specific operating conditions. In case the operating parameters of the asset(s) are changed, the same may be reflected in the outcome of the trained machine model. For example, when operating parameters of the assets change, such changes are reflected in the outcome of the trained machine learning model, ensuring that the model remains relevant and accurate even as operational conditions evolve.

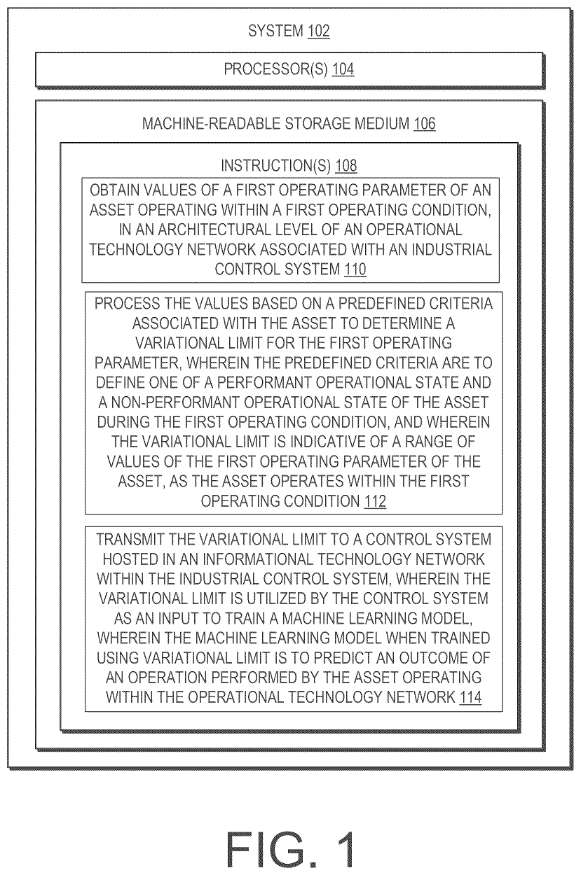

FIG. 1 illustrates system 102 for determining a variational limit(s) of an operating parameter of an asset, as per one example. The determination of the variational limit(s) of an operating parameter of an asset(s) is based on one or more operating parameters observed for one or more asset(s) over a period of time, in accordance with an example of the present subject matter. The one or more operating parameters may reflect the operational history or current conditions of the one or more asset(s). The system 102 includes a processor 104, and a machine-readable storage medium 106 which is coupled to, and accessible by, the processor 104. The system 102 may be implemented in any computing system, such as a storage array, server, desktop or a laptop computing device, a distributed computing system, or the like. Although not depicted, the system 102 may include other components, such as interfaces to communicate over the network or with external storage or computing devices, display, input/output interfaces, operating systems, applications, data, and the like, which have not been described for brevity.

The processor 104 may be implemented as a dedicated processor, a shared processor, or a plurality of individual processors, some of which may be shared. The machine-readable storage medium 106 may be communicatively connected to the processor 104. Among other capabilities, the processor 104 may fetch and execute computer-readable instructions, including instructions 108, stored in the machine-readable storage medium 106. The machine-readable storage medium 106 may include non-transitory computer-readable medium including, for example, volatile memory such as RAM (Random Access Memory), or non-volatile memory such as EPROM (Erasable Programmable Read Only Memory), flash memory, and the like. The instructions 108 may be executed to classify the hardware components of the computing device.

In an example, the processor 104 may fetch and execute instructions 108. In one example, as a result of the execution of the instructions 110, the system 102 may obtain values of a first operating parameter of an asset(s) operating within a first operating condition. The asset(s) may be operating in an architectural level of an operational technology network (OTN), associated with an industrial control system. In one example, the asset(s) may include, but is not be limited to, one of a machinery, equipment, and infrastructure components operating within an industrial process executing in the OTN of the industrial control systems. In one example, the first operating parameter may, but is not limited to, one of a temperature, pressure, duty cycle, and load capacity of the asset(s) operating during an industrial process.

Once the values of the first operating parameter are obtained, the instructions 112 may be executed to process the values based on a predefined criteria associated with the asset. The predefined criteria may pertain to one of a performant operational state and a non-performant operational state of the asset. The predefined criteria may include, but is not limited to, one of a threshold value for the first operating parameter, a rate of change limit for the first operating parameter and a duration for the first operating parameter to remain operational within a specific range. The values of the first operating parameter are processed to determine a variational limit(s) for the first operating parameter. In on example, the variational limit(s) may be indicative of a range of values of the first operating parameter of the asset, as the asset(s) operates within the first operating condition.

Once the variational limit(s) is determined, the instructions 114 may be executed to transmit the variational limit(s) to a control system. The control system may be hosted in an informational technology network within the industrial control systems. In one example, the variational limit(s) may be utilized by the control system as an input to train a machine learning model. In one example, the machine learning model when trained may predict, using the variational limit, an outcome of an operational performed by the asset(s) operating within the OTN.

The above functionalities performed as a result of the execution of instructions 108, may be performed by different programmable entities. Such programmable entities may be implemented through neural network-based computing systems, which may be implemented either on a single computing device, or multiple computing devices.

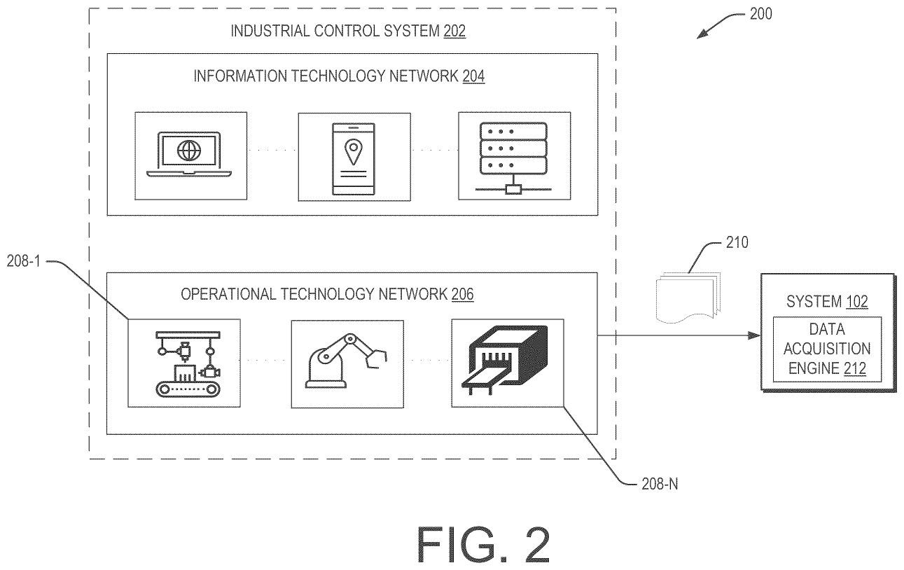

FIG. 2 illustrates an environment 200 of an industrial control system 202, as per an example. The industrial control systems 202 may be associated with a system, such as the system 102 used for determining a variational limit(s) of an operating parameter of an asset. In one example, the industrial control system 202 comprises of two physical networks—an IT network 204 (or ITN 204) and an OT network 206 (or an OTN 206). The OTN 206 includes programmable control systems and/or devices that may interact with physical environments or may manage devices that interact with the physical environments. Such systems and/or devices (referred as asset(s) 208-1, . . . 208-N, collectively referred as asset(s) 208)) may detect or cause a direct change through the monitoring and/or control of devices, processes, and events. On the other hand, the IT network 204 includes systems and/or devices for orchestration of operations of the asset(s) 208 operating in the OTN 206. The asset(s) 208 may be deployed in any of multiple architectural levels of the industrial control system 202.

Although not depicted the industrial control system 202 may implement a plurality of architectural levels. One example of an industrial control system implementing such architectural levels is the Purdue Model, also known as the Purdue Enterprise Reference Architecture (PERA). The example model divides an industrial enterprise into five distinct levels, each representing different functions and responsibilities. Such models provide a structured approach for designing, integrating, and managing automated systems within an enterprise. In an example, although not depicted the asset(s) 208 may be deployed in any of multiple architectural levels of the industrial control system 202.

Continuing with the present example, the asset(s) 208 may include any machinery, components, or equipment that may be used in a commercial, industrial facility of an organization. Examples may include, but are not limited to, pipelines, liquid storage tanks, vehicles, air pumps, cranes, condensers, or filters. Further, each of the asset(s) 208 may be provided with a sensor (not depicted in FIG. 2). The sensor may be used to track various mechanical, functional, or operational metrics regarding the assets. For example, if asset(s) is a pipe, the sensor may include fill level, flow rate, pressure, and/or temperature sensors. Some sensors may detect vibrations or energy usage. In an example, the system 102 may be coupled to the sensor to receive raw data from the sensor that are monitoring the assets. The system 102 may further be able to identify which raw data comes from which sensor and associate it with the corresponding asset(s) 208.

The system 102 may be communicatively coupled with the industrial control system 202 over a network (not shown in FIG. 2). The network may be a private network or a public network and may be implemented as a wired network, a wireless network, or a combination of a wired and wireless network. The network may also include a collection of individual networks, interconnected with each other and functioning as a single large network, such as the Internet. Examples of such individual networks include, but are not limited to, Global System for Mobile Communications (GSM) network, Universal Mobile Telecommunications System (UMTS) network, Personal Communications Service (PCS) network, Time Division Multiple Access (TDMA) network, Code Division Multiple Access (CDMA) network, Next Generation Network (NGN), Public Switched Telephone Network (PSTN), Long Term Evolution (LTE), and Integrated Services Digital Network (ISDN).

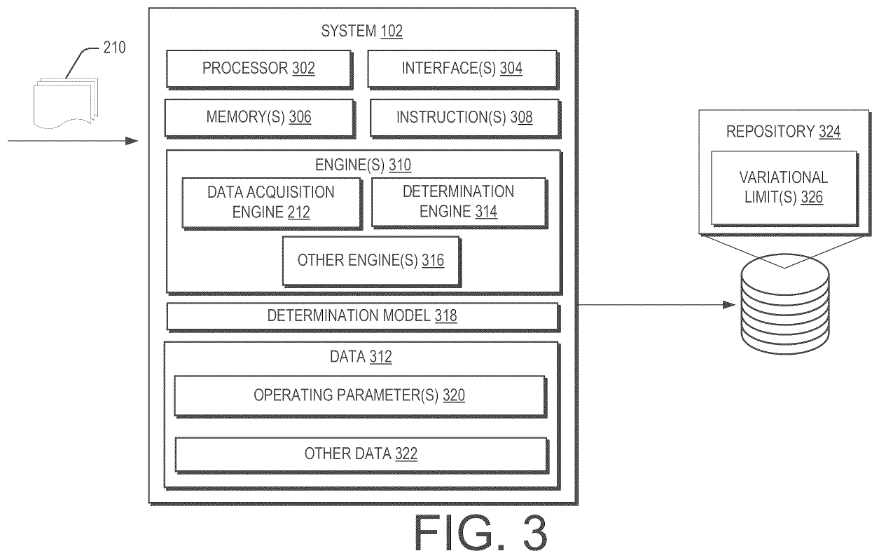

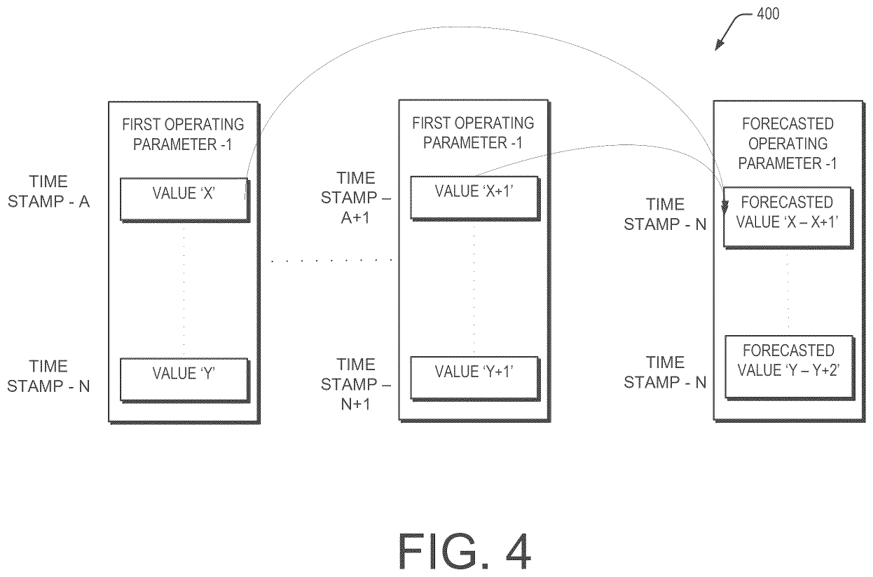

Each of these asset(s) 208 may have multiple operating parameters (for example, first operating parameter, second operating parameter, and so on). Values of the multiple operating parameters may be retrieved from the asset(s) 208, as operational data 210, and stored in a data repository (not shown in FIG. 2). The operational data 210 may be processed by a system 102, to determine a variational limit(s) (as will be explained in FIGS. 3-4). In one example, the system 102 may include one or more engines, such as a data acquisition engine 212. The data acquisition engine 212 may be implemented as a combination of hardware and programming, for example, programmable instructions to implement a variety of functionalities. In examples described herein, such combinations of hardware and programming may be implemented in several different ways. For example, the programming for the data acquisition engine 212 may be executable instructions. Such instructions may be stored on a non-transitory machine-readable storage medium which may be coupled either directly with the system 102 or indirectly (for example, through networked means).

In an example, the data acquisition engine 212 may include a processing resource, for example, either a single processor or a combination of multiple processors, to execute such instructions. In the present examples, the non-transitory machine-readable storage medium may store instructions, that when executed by the processing resource, implement the data acquisition engine 212. In other examples, the data acquisition engine 212 may be implemented as electronic circuitry.

The data acquisition engine 212 may obtain values of the first operating parameter of the asset(s) 208, and process the values based on a predefined criteria associated with the asset(s) 208. The predefined criteria may include, but is not limited to, one of a threshold value for the first operating parameter, a rate of change limit for the first operating parameter and a duration for the first operating parameter to remain operational within a specific range. The predefined criteria may pertain to one of a performant operational state and a non-performant operational state of the asset(s) 208. The data acquisition engine 212 may process the values of the first operating parameter to determine a variational limit(s) for the first operating parameter (as will be explained in detail in FIGS. 3-4).

FIG. 3 illustrates the system 102 along with its functional components, wherein the system 102 is for determining a variational limit, as per an example. The system 102 includes a processor 302, interface(s) 304, and memory(s) 306. The processor 302 may be implemented as microprocessors, microcomputers, microcontrollers, digital signal processors, central processing units, state machines, logic circuitries, and/or other devices that manipulate signals based on operational instructions. The interface(s) 304 may allow the connection or coupling of the system 102 with one or more other devices, through a wired (e.g., Local Area Network, i.e., LAN) connection or through a wireless connection (e.g., Bluetooth®, Wi-Fi). The interface(s) 304 may also enable intercommunication between different logical as well as hardware components of the system 102. The interface(s) 304 may also enable the system 102 to communicate with other entities, such as a data repository, or other devices or systems (not shown in the figures) which may be present within an industrial control system, such as the industrial control system 202, as shown in FIG. 2.

The memory(s) 306 may be a computer-readable medium, examples of which include volatile memory (e.g., RAM), and/or non-volatile memory (e.g., Erasable Programmable read-only memory, i.e., EPROM, flash memory, etc.). The memory(s) 306 may be an external memory, or internal memory, such as a flash drive, a compact disk drive, an external hard disk drive, or the like. The memory(s) 306 may further include data which either may be utilized or generated during the operation of the system 102.

The system 102 may further include instructions 308, engine(s) 310 and data 312. In an example, the instructions 308 are fetched from the memory 306 and executed by the processor 302 included within the system 102. The engine(s) 310 may be implemented as a combination of hardware and programming, for example, programmable instructions to implement a variety of functionalities of the engine(s) 310. In examples described herein, such combinations of hardware and programming may be implemented in several different ways. For example, the programming for the engine(s) 310 may be executable instructions. Such instructions may be stored on a non-transitory machine-readable storage medium which may be coupled either directly with the system 102 or indirectly (for example, through networked means).

In an example, the engine(s) 310 may include a processing resource, for example, either a single processor or a combination of multiple processors, to execute such instructions. In the present examples, the non-transitory machine-readable storage medium may store instructions that, when executed by the processing resource, implement engine(s) 310. In other examples, the engine(s) 310 may be implemented as electronic circuitry. In one example, the engine(s) 310 may be implemented through a machine-learning model that implements machine-learning techniques, statistical techniques, or probabilistic techniques. Examples of such techniques may include expert systems, support vector machines (SVM), neural networks, or the like.

The engine(s) 310 includes a determination engine 314, a data acquisition engine 212 (as shown in FIG. 2), and other engine(s) 316. The other engine(s) 316 may further implement functionalities that supplement functions performed by the system 102 or any of the engine(s) 310. The data 312, on the other hand, includes data that is either stored or generated as a result of functions implemented by any of the engine(s) 310 or the system 102. It may be further noted that information stored and available in data 312 may be utilized by the engine(s) 310 for performing various functions to be implemented by the system 102. In an example, data 312 may include an operating parameter(s) 320, and other data 322. The other data 322, includes data that is either stored or generated as a result of functions implemented by any of the engine(s) 310 or the system 102. It may be noted that such examples of the various functional blocks as depicted in FIG. 3 are indicative. The present approaches may be applicable to other examples without deviating from the scope of the present subject matter. The operation of the system 102 is explained in conjunction with the environment 200 as depicted in FIG. 2.

For determining the variational limit, the data acquisition engine 212 may obtain values of multiple operating parameters 320 (for example, first operating parameter, second operating parameter, and so on) of the asset(s) 208, stored as operational data 210. The operating parameter(s) 320 may be obtained in response to a command, or the data acquisition engine 212 may be configured to retrieve the operating parameter(s) 320 from the repository 324 at predefined intervals or specified time instants. For example, the operating parameter(s) 320 may be obtained from asset(s) 208, including, but not limited to, any machinery, vehicles, or equipment that is used in a commercial or industrial facility or organization.

The system 102 may further include a determination model 318. The determination model 318 may be a statistical based model such as regression-based models, principal component analysis (PCA) models, and more, or an artificial intelligence-based machine learning model, without deviating from the scope of the present subject matter. As will be explained, the determination model 318 may be implemented with the determination engine 314, to determine a variational limit(s) of an operating parameter of an asset, such as asset(s) 208 operating in the OTN 206 of the industrial control system 202. Since, each of these asset(s) 208 have multiple operating parameter(s) 320, associated thereof, values of the multiple operating parameter(s) 320 of the asset(s) 208 may be obtained. Once values of the operating parameter(s) 320 are obtained, the determination engine 314 may process the values.

In one example, the determination engine 314 may process the values based on a predefined criteria associated with the asset(s) 208. The predefined criteria may pertain to one of a performant operational state and a non-performant operational state of the asset(s) 208. The processing of the values based on the predefined criteria pertaining to evaluating performance of the asset(s) under different operational conditions. In one example, the predefined criteria may include, but is not limited to, one of a threshold value for the first operating parameter 320, a rate of change limit for the first operating parameter 320 and a duration for the first operating parameter 320 to remain operational within a time-interval.

The determination engine 314 may process the values of the first operating parameter to determine a variational limit(s) for the first operating parameter. In one example, the variational limit(s) may be determined by implementing a statistical measure of the values of the operating parameter(s) 320. For example, the statistical measure may include, but is not limited to, determining one or more of a mean, a median, a standard deviation, and an interquartile range of the values, to determine the variational limit(s). For example, if values of the operating parameter 320 is ‘X’ at a given time instant, and is ‘X+2’ at another time instant, under the same operating conditions, the variational limit(s) corresponding to the value of the operating parameter(s) 320, may be construed as a value being one or more of the mean, the median, the standard deviation, and the interquartile range of the values ‘X’ and ‘X+2’, respectively.

The variational limit(s) may be indicative of a range of values of the first operating parameter of the asset(s) 208 as the asset(s) 208 operates during the first operating condition. Once the variational limit(s) is determined by system 102, the same may be stored as ‘variational limit(s) 326’ in a repository 324. The determination of the variational limit(s) 326 is further explained in conjunction with FIG. 4. As will be explained in detail, to determine the variational limit(s), one or more values of the operating parameter(s) 320 may be forecasted. The forecasted parameter values may then be used for determining the variational limit(s). Although the present example depicts the system 102 to be directly coupled to the asset(s) 208, the system 102 may be coupled to other intermediate computing devices or systems, such as process control systems, data acquisition systems, or centralized monitoring platforms, which facilitates data collection, preprocessing, or distribution, without deviating from the scope of the present subject matter.

FIG. 4 illustrates an illustration 400 for determining the variational limit(s) 326, as per an example. FIG. 4 demonstrates by way of the illustrated example, the manner in which a forecasted operating parameter is obtained based on values of the first operating parameter 320 at different time instants. The determination of the variational limit(s) 326 is explained in conjunction with system 102 of FIG. 3. As explained previously, once values of the operating parameter(s) 320 are obtained, the determination engine 314 may process the values based on a predefined criteria associated with the asset(s) 208. The predefined criteria may pertain to one of a performant operational state and a non-performant operational state of the asset(s) 208. The determination engine 314 may process the values of the first operating parameter to determine a variational limit(s) for the first operating parameter 320. The variational limit(s) may be indicative of a range of values of the first operating parameter of the asset(s) 208 as the asset(s) 208 operates during the first operating condition.

In an example, as shown in FIG. 4, values of the first operating parameter (values ‘X’, . . . , ‘Y’) from a time stamp ‘A’, . . . , ‘N’ may be obtained by the determination engine 314. For example, the first operating parameter may be ‘temperature’ of a pressure valve (asset(s) 208), operating in the OTN 206. Values of the temperature may be recorded at multiple time intervals, for example, at intervals of 10 minutes, 30 minutes, 60 minutes, and so on, as per below table 1:

| Date | Time | Temperature (deg Celsius) |
|---|---|---|
| 27 Jan. 2024 | 10:00:00 | 35 |
| | 11:00:00 | 36 |
| | 12:00:00 | 37 |
| | 13:00:00 | 36 |

Similarly, values of the first operating parameter (values ‘X+1’, . . . , ‘Y+1’) from a time stamp ‘A+1’, . . . , ‘N+1’ may be obtained by the determination engine 314. For example, the first operating parameter may be ‘temperature’ of a pressure valve (asset(s) 208). Values of the temperature may be recorded at multiple time intervals, for example, at intervals of 10 minutes, 30 minutes, 60 minutes, and so on, as per below table 2:

| Date | Time | Temperature (deg Celsius) |
|---|---|---|
| 27 Jan. 2024 | 11:00:00 | 36 |
| | 12:00:00 | 37 |
| | 13:00:00 | 38 |
| | 14:00:00 | 37 |

The determination engine 314 may determine a correlation between the values of the first operating parameter 320 obtained at a first-time stamp and the values of the first operating parameter obtained at a later time stamp and determine a range of values of the first operating parameter. In one example, the determination engine 314 for determining the correlation between values of the first operating parameter 320, may obtain a statistical measure of the obtained values of the first operating parameter 320. For example, the statistical measure may include, but is not limited to, one or more of a mean, a median, a standard deviation, and an interquartile range. Once obtained, the determination engine 314 may determine an upper bound and a lower bound for the variational limit(s) 326 based on determined statistical measure.

In one example, the determination engine 314 may also obtain values of a second operating parameter 320 of the asset(s) 208 in a second operating condition. Based on processing of the values of the second operating parameter 320, the determination engine, may obtain a trend of values of each of the first operating parameter 320 and the second operating parameter 320. In one example, the trend may be one of pattern and direction of change observed in the values of the first and the second operating parameters 320. For example, trend may include, but is not limited to, one of temporal trends and non-temporal trends between values of operating parameters, wherein the temporal trend may include, but not limited to, a short-term fluctuation, long-term trend, cyclic trend, seasonal variations, sudden spikes, sudden drops, periods of stability, rate of change over different time scales, and moving averages and the non-temporal trends includes linear correlation, inverse relation, non-linear correlation, hysteresis relation, oscillatory relation, ratio relation, lag relation, conditional relation, and threshold relation.

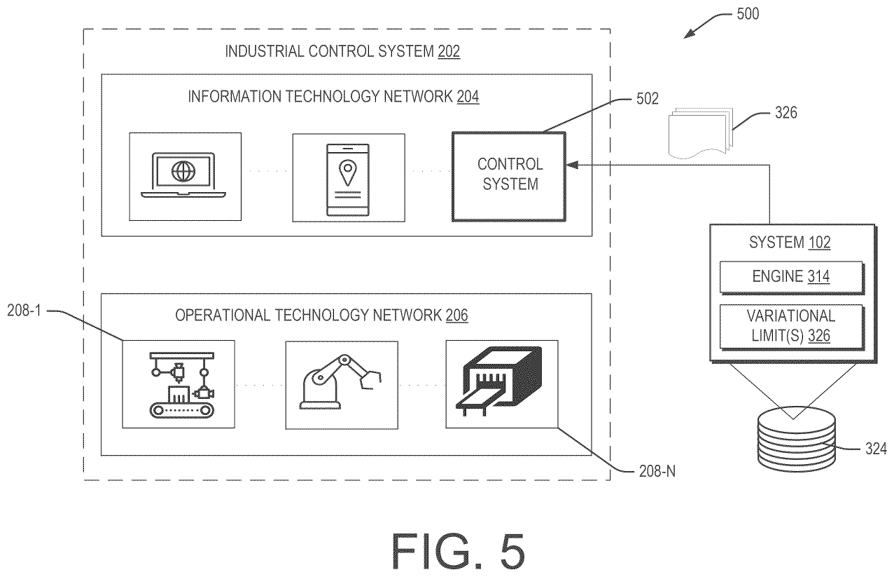

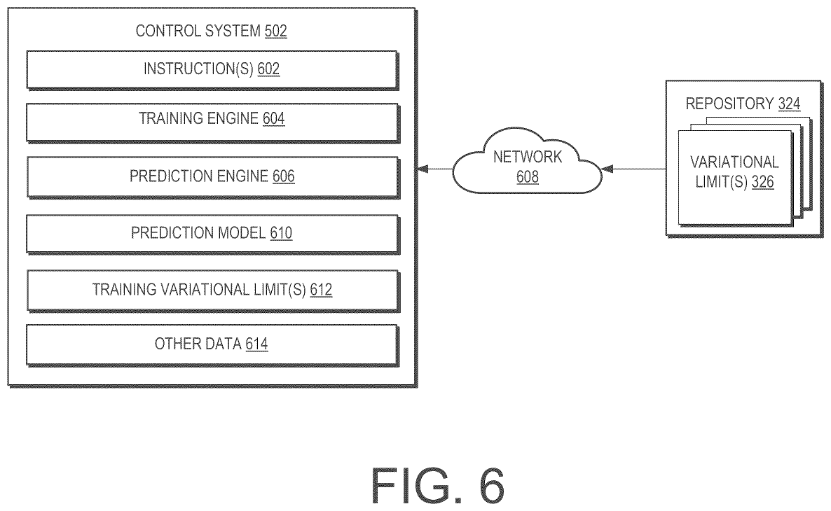

For example, based on a correlation determined by determination engine 314 and from above Tables 1 and 2, it may be inferred that the values of ‘temperature’ at ‘11:00:00’ hours may be between a range of 36-37 deg Celsius. The values inferred may be recorded as forecasted values defining a range of values (variational limit) of the first operating parameter at different time intervals. Once the determination is made, the determination engine 314 may transmit the variational limit(s) 326 (stored as variational limit(s) 326) to a control system operating in an informational technology network of the industrial control system 202 (as will be explained in FIGS. 5-6), for training a machine learning model.

Additionally, once the variational limit(s) is determined, the determination engine 314 may determine a performance indicator value of the asset(s) 208 based on the determined variational limit. In one example, the determination engine 314 may associate the performance indicator value of the asset(s) 208 with an operational recommendation, wherein the operational recommendation defines an optimization to be applied to the asset(s) to adjust performance of the asset(s) 208. The same may also be transmitted to the control system for training the machine learning model (as will be explained in detail FIGS. 5-6).

FIG. 5 illustrates another environment 500 which implements an industrial control system 202 (as shown in FIG. 2), as per an example. Similar to environment 200, the industrial control systems 202 (as shown in FIG. 5) may be communicatively coupled with a system, such as the system 102 used for determining a variational limit(s) of an operating parameter of an asset, and transmitting the determined variational limit(s) to a control system, as will be explained further.

Similar to environment 200 of FIG. 2, system 102 may be communicatively coupled with the industrial control system 202 over a network (not shown in FIG. 5). The network may be a private network or a public network and may be implemented as a wired network, a wireless network, or a combination of a wired and wireless network. The network may also include a collection of individual networks, interconnected with each other and functioning as a single large network, such as the Internet. Examples of such individual networks include, but are not limited to, Global System for Mobile Communications (GSM) network, Universal Mobile Telecommunications System (UMTS) network, Personal Communications Service (PCS) network, Time Division Multiple Access (TDMA) network, Code Division Multiple Access (CDMA) network, Next Generation Network (NGN), Public Switched Telephone Network (PSTN), Long Term Evolution (LTE), and Integrated Services Digital Network (ISDN).

Similar to environment 200 of FIG. 2, the determination engine 314 may be implemented as a combination of hardware and programming, for example, programmable instructions to implement a variety of functionalities. In examples described herein, such combinations of hardware and programming may be implemented in several different ways. For example, the programming for engine(s), such as the determination engine 314 may be by way of executable instructions. Such instructions may be stored on a non-transitory machine-readable storage medium which may be coupled either directly with the system 102 or indirectly (for example, through networked means). In an example, the engine(s) 314 may include a processing resource, for example, either a single processor or a combination of multiple processors, to execute such instructions. In the present examples, the non-transitory machine-readable storage medium may store instructions, that when executed by the processing resource, implement the data acquisition engine 212. In other examples, the data acquisition engine 212 may be implemented as electronic circuitry.

As discussed previously, the industrial control system 202 comprises of two physical networks—an IT network 204 (or ITN 204) and an OT network 206 (or an OTN 206). The asset(s) 208 may include any machinery, vehicles, or equipment that is used in a commercial or industrial facility or organization. The system 102, and in turn the determination engine 314, may further be able to identify which raw data comes from which sensor and associate it with the corresponding asset(s) 208.

In one example, the determination engine 314 of the system 102 may transmit the variational limit(s) (stored as ‘variational limit(s) 326’) to a control system, such as a control system 502. The variational limit(s) are determined by the system 102, as explained in conjunction with FIG. 3. For example, the variational limit(s) are determined by obtaining values of multiple operating parameter(s) 320 (for example, first operating parameter, second operating parameter, and so on). Once values of the operating parameter(s) 320 are obtained, the values are processed by the determination engine 314, based on a predefined criteria associated with the asset(s) 208. The predefined criteria may pertain to one of a performant operational state and a non-performant operational state of the asset(s) 208. In one example, the predefined criteria may include, but is not limited to, one of a threshold value for the first operating parameter 320, a rate of change limit for the first operating parameter 320 and a duration for the first operating parameter 320 to remain operational within a time-interval. The variational limit(s) may be indicative of a range of values of the first operating parameter of the asset(s) 208 as the asset(s) 208 operates during the first operating condition.

Once the variational limit(s) is determined by system 102, the same, stored as ‘variational limit(s) 326’ in the repository 324, may be transmitted to the control system 502. The control system may be hosted in the ITN 204 within the industrial control system 202. In one example, variational limit(s) 326 may be utilized by the control system 502 as an input to train a machine learning model (as will be explained in FIG. 6). In one example, the machine learning model when trained may predict, using the variational limit, an outcome of an operation performed by the asset(s) 208 operating within the OTN 206, as will be explained further.

FIG. 6 illustrates the control system 502 along with its functional components, wherein the control system 502 is for training a machine learning model, as per an example. In an example, the control system 502 (referred to as system 502) may be communicatively coupled to a repository 324 through a network 608. The repository 324 may further include variational limit(s) 326.

The variational limit(s) 326, although depicted as being obtained from a single repository, such as the repository 324, may also be obtained from multiple other sources without deviating from the scope of the present subject matter. In such cases, each of such multiple repositories may be interconnected through a network, such as the network 608. The network 608 may be a private network or a public network and may be implemented as a wired network, a wireless network, or a combination of a wired and wireless network. The network 608 may also include a collection of individual networks, interconnected with each other and functioning as a single large network, such as the Internet. Examples of such individual networks include, but are not limited to, Global System for Mobile Communications (GSM) network, Universal Mobile Telecommunications System (UMTS) network, Personal Communications Service (PCS) network, Time Division Multiple Access (TDMA) network, Code Division Multiple Access (CDMA) network, Next Generation Network (NGN), Public Switched Telephone Network (PSTN), Long Term Evolution (LTE), and Integrated Services Digital Network (ISDN).

The system may further include instructions 602, a training engine 604, a prediction engine 606, a prediction model 610 (interchangeably referred as a machine learning model), and other data 614. The other data 614, on the other hand, includes data that is either stored or generated as a result of functions implemented by any of the engine(s) 604, 606 or the system 502.

In an example, the instructions 602 are fetched from a memory and executed by a processor included within the system 502. The training engine 604 and the prediction engine 606 may be implemented as a combination of hardware and programming, for example, programmable instructions to implement a variety of functionalities. In examples described herein, such combinations of hardware and programming may be implemented in several different ways. For example, the programming for the training engine 604 and the prediction engine 606 may be executable instructions, such as instructions 602. Such instructions may be stored on a non-transitory machine-readable storage medium which may be coupled either directly with the system 502 or indirectly (for example, through networked means). In an example, the training engine 604 and the prediction engine 606 may include a processing resource, for example, either a single processor or a combination of multiple processors, to execute such instructions. In the present examples, the non-transitory machine-readable storage medium may store instructions, such as instructions 602, that when executed by the processing resource, implement the training engine 604 and the prediction engine 606. In other examples, the training engine 604 and the prediction engine 606 may be implemented as electronic circuitry.

The instructions 602, when executed by the processing resource, cause the training engine 604 to train an artificial intelligence-based machine learning model such as the prediction model 610. In an example, the prediction model 610 is trained based on the variational limit(s) 326. The variational limit(s) 326 may pertain to variational limit(s) determined for a plurality of asset(s) 208 operating across multiple architectural levels in an operational technology network (for example, the OTN 206) of an industrial control system (for example, the industrial control system 202), as explained in conjunction to FIGS. 2-5.

For example, the variational limit(s) 326 are determined by obtaining values of multiple operating parameter(s) 320 (for example, first operating parameter, second operating parameter, and so on). Once values of the operating parameter(s) 320 are obtained, the values are processed by the determination engine 314, based on a predefined criteria associated with the asset(s) 208. The predefined criteria may pertain to one of a performant operational state and a non-performant operational state of the asset(s) 208. In one example, the predefined criteria include, but is not limited to, one of a threshold value for the first operating parameter 320, a rate of change limit for the first operating parameter 320 and a duration for the first operating parameter 320 to remain operational within a time-interval. The variational limit(s) may be indicative of a range of values of the first operating parameter of the asset(s) 208 as the asset(s) 208 operates during the first operating condition.

Once the variational limit(s) is determined by system 102, the same, stored as ‘variational limit(s) 326’ in the repository 324, may be transmitted to the control system 502. In an example, the system 502 may obtain the variational limit(s) 326 at one time, or in batches, from the repository 324.

In operation, the system 502 may obtain the variational limit(s) 326 from the repository 324, and the data included in the variational limit(s) 326 may further be stored as training variational limit(s) 612, in the system 502. The training engine 604 is to train the prediction model 610 over a period of time, based on the variational limit(s) 326. The prediction model 610 may be trained based on values conforming to the variational limit(s) 326. For instance, values of the variational limit(s) 326 of the plurality of asset(s) 208 may be continuously monitored, to train the prediction model 610.

In one example, the prediction engine 606 is to predict an outcome of an operation performed by the asset(s) 208, operating within the OTN 206. The prediction model 610 when trained may be utilized to determine prospective operational results of the asset(s) 208, operating within the OTN 206. For example, current operational data of the asset(s) 208 operating within the OTN 206 may be received, which may include multiple operating parameter(s) 320 of the asset(s) 208. The prediction model 610 once trained, may be implemented to identify a comparison between current values of the operating parameter(s) 320, against the respective variational limit(s) 326, and identify if any operating parameter(s) 320 is deviating from expected operational range(s).

For example, in the context of a key performance indicator (KPI) system and an event and alarm management (EAM) system, operating within the industrial control system 202, the prediction engine 606 is to predict an outcome related to performance of the asset(s) 208 and operational condition(s) under which the asset(s) 208 operates, within the industrial control system 202. For example, in a manufacturing production line of the industrial control system 202, a critical KPI may be, for instance, overall equipment effectiveness (OEE). The prediction model 610 may be trained to determine that the OEE for a specific production line may drop a certain value, for example, from 85% to 78% in the next 24 hours. This may be due to a gradual degradation in equipment performance, as indicated by subtle changes in operating parameters of the asset(s) 208.

Similarly, in a chemical processing unit of the industrial control system 202, the prediction engine 606 is to predict an alarming condition(s) before occurrence. For example, based on the variational limit(s) of temperature and pressure in a ‘reactor vessel’ (asset(s) 208), the prediction engine 606 is to predict that there may be a 75% probability of a high-pressure alarm event occurring within the next 24 hours, provided the current operational conditions continue.

Based on the above, the prediction model 610 may be trained to provide an integrated data analysis by correlating KPI metrics with specific operating parameters, monitored by the EAM system. While predicting a decline in a KPI of the asset(s) 208, the prediction model 610, when trained may also identify a specific operating parameter of the asset(s) 208, likely to be responsible, based on data provided by the EAM system. Accordingly, the prediction model 610 may be trained to provide a unified framework for understanding and predicting performance of the asset(s) 208 operating across multiple architectural levels of the OTN 206.

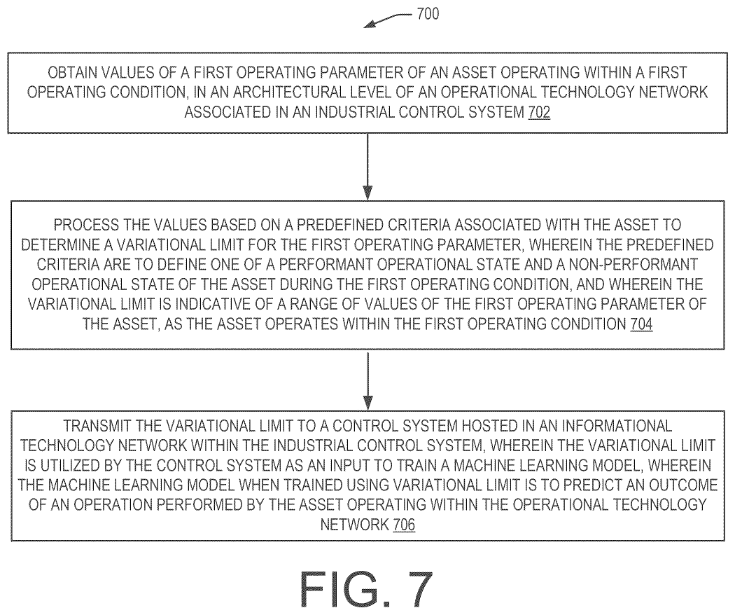

FIG. 7 illustrates a method 700 for determining a variational limit(s) of an operating parameter of an asset, as per an example. The order in which the above-mentioned method 700 described is not intended to be construed as a limitation, and some of the described method blocks may be combined in a different order to implement the method, or an alternative method.

In an example, the above-mentioned method 700 may be implemented by a data acquisition engine 212 and a determination engine (such as determination engine 314) of the system 102, in conjunction with FIGS. 2-4. The above-mentioned method 700 is explained from the perspective of an operating parameter(s) of an asset(s) 208 operating in an architectural level of an operational technology network, for example, OTN 206, in an industrial control system, for example, the industrial control system 202.

At block 702, values of a first operating parameter of an asset(s) operating in a first operating condition is obtained. For example, each of these asset(s) 208 may have multiple operating parameters (for example, first operating parameter, second operating parameter, and so on). Values of the multiple operating parameters may be retrieved from the asset(s) 208, as operational data 210, by the data acquisition engine 212. The asset(s) 208 may be operating in an architectural level of OTN 206 of the industrial control system 202. In one example, the asset(s) 208 may include, but is not be limited to, one of a machinery, equipment, and infrastructure components operating within an industrial process executing in the OTN 206 of the industrial control systems 202. In one example, the first operating parameter may, but is not limited to, one of a temperature, pressure, duty cycle, and load capacity of the asset(s) operating during an industrial process executing within the OTN 206.

At block 704, values of the first operating parameter are processed. In one example, once the values of the first operating parameter are obtained, the determination engine 314 may process the values based on a predefined criteria associated with the asset. The predefined criteria may pertain to one of a performant operational state and a non-performant operational state of the asset(s) 208. The data acquisition engine 212 may process the values of the first operating parameter to determine a variational limit(s) for the first operating parameter. In on example, the variational limit(s) may be indicative of a range of values of the first operating parameter of the asset, as the asset(s) operates within the first operating condition.

At block 706, variational limit(s) is transmitted. In one example, once the variational limit(s) is determined, the determination engine 314 may transmit the variational limit(s) to a control system, such as the control system 502, as shown in FIGS. 5-6. The control system may be hosted in an informational technology network, for example, the ITN 204, within the industrial control system 202. In one example, the variational limit(s) may be utilized by the control system 502 as an input to train a machine learning model. In one example, the machine learning model when trained may predict, using the variational limit, an outcome of an operational performed by the asset(s) operating within the OTN 206.

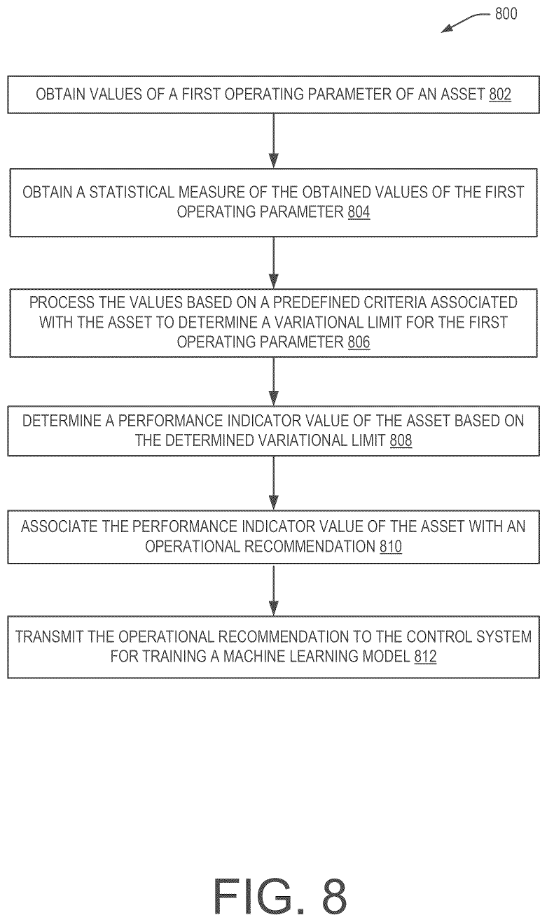

FIG. 8 illustrates a detailed method 800 for determining a variational limit(s) of an operating parameter of an asset, as per an example. The order in which the above-mentioned method 800 is described is not intended to be construed as a limitation, and some of the described method blocks may be combined in a different order to implement the method, or an alternative method.

In an example, the above-mentioned method 800 methods may be implemented by a data acquisition engine 212 and a determination engine (such as determination engine 314) of the system 102, in conjunction with FIGS. 2-4. The above-mentioned method 800 is explained from the perspective of an operating parameter(s) of an asset(s) 208 operating in an architectural level of an operational technology network, for example, OTN 206, in an industrial control system, for example, the industrial control system 202.

At block 802, values of a first operating parameter of an asset(s) operating in a first operating condition is obtained. For example, each of these asset(s) 208 may have multiple operating parameters (for example, first operating parameter, second operating parameter, and so on). The data acquisition engine 212 may obtain values of the first operating parameter of the asset(s) 208, and process the values based on a predefined criteria associated with the asset(s) 208. The asset(s) 208 may be operating in an architectural level of OTN 206 of the industrial control system 202. In one example, the first operating parameter may, but is not limited to, one of a temperature, pressure, duty cycle, and load capacity of the asset(s) operating during an industrial process executing within the OTN 206.

At block 804, a statistical measure of the obtained values, is obtained. For example, the determination engine 314 may determine a correlation between the values of the first operating parameter 320 obtained at a first-time stamp and the values of the first operating parameter obtained at a later time stamp and determine a range of values of the first operating parameter. In one example, the determination engine 314 for determining the correlation between values of the first operating parameter 320, may obtain a statistical measure of the obtained values of the first operating parameter 320.

For example, the statistical measure may include, but is not limited to, determining one or more of a mean, a median, a standard deviation, and an interquartile range of the values, to determine the variational limit(s). For example, if values of the operating parameter 320 is ‘X’ at a given time instant, and is ‘X+2’ at another time instant, under the same operating conditions, the variational limit(s) corresponding to the value of the operating parameter(s) 320, may be construed as a value being one or more of the mean, the median, the standard deviation, and the interquartile range of the values ‘X’ and ‘X+2’, respectively. Once obtained, the determination engine 314 may determine an upper bound and a lower bound for the variational limit(s) based on determined statistical measure.

At block 806, values of the first operating parameter are processed. As explained previously, the determination engine 314 may process the values based on a predefined criteria associated with the asset(s) 208. The predefined criteria may pertain to one of a performant operational state and a non-performant operational state of the asset(s) 208. The determination engine 314 may process the values of the first operating parameter to determine a variational limit(s) for the first operating parameter 320. The variational limit(s) may be indicative of a range of values of the first operating parameter of the asset(s) 208 as the asset(s) 208 operates during the first operating condition.

In an example, values of the first operating parameter (values ‘X’, . . . , ‘Y’) from a time stamp ‘A’, . . . , ‘N’ may be obtained by the determination engine 314. For example, the first operating parameter may be ‘temperature’ of a pressure valve (asset(s) 208), operating in the OTN 206. Values of the temperature may be recorded at multiple time intervals, for example, at intervals of 10 minutes, 30 minutes, 60 minutes, and so on, as per below table 1 explained in conjunction to FIG. 4:

| Date | Time | Temperature (deg Celsius) |
|---|---|---|
| 27 Jan. 2024 | 10:00:00 | 35 |
| | 11:00:00 | 36 |
| | 12:00:00 | 37 |
| | 13:00:00 | 36 |

Similarly, values of the first operating parameter (values ‘X+1’, . . . , ‘Y+1’) from a time stamp ‘A+1’, . . . , ‘N+1’ may be obtained by the determination engine 314. For example, the first operating parameter may be ‘temperature’ of a pressure valve (asset(s) 208). Values of the temperature may be recorded at multiple time intervals, for example, at intervals of 10 minutes, 30 minutes, 60 minutes, and so on, as per below table 2 explained in conjunction to FIG. 4:

| Date | Time | Temperature (deg Celsius) |
|---|---|---|
| 27 Jan. 2024 | 11:00:00 | 36 |
| | 12:00:00 | 37 |
| | 13:00:00 | 38 |
| | 14:00:00 | 37 |

At block 808, performance indicator value of the asset(s) 208 is determined. In one example, once the variational limit(s) is determined, the determination engine 314 may determine a performance indicator value of the asset(s) 208 based on the determined variational limit. The performance of the asset(s) 208 may be evident through a plurality of key performance indicators (KPIs), which provide quantitative measures of the asset(s) 208 efficiency, productivity, and output quality.

At block 810, the performance indicator of the asset(s) 208 is associated with an operational recommendation. In one example, the determination engine 314 may associate the performance indicator value of the asset(s) 208 with an operational recommendation, wherein the operational recommendation defines an optimization to be applied to the asset(s) to adjust performance of the asset(s) 208. The operational recommendation may also pertain to recommendations regarding optimizing operations, scheduling timely maintenance, and enhance overall efficiency of the asset(s) 208 under consideration.

At block 812, the operational recommendation is transmitted to a control system. In one example, the operational recommendations may be transmitted to the control system for training a machine learning model. The control system, such as the control system 502 may be hosted in the ITN 204 of the industrial control system 202. The machine learning model, once trained, may be used to estimate the value of the operating parameter(s) 320 of the asset(s) 208, which may be applied to the asset(s) 208 to achieve the desired value of the performance indicator.

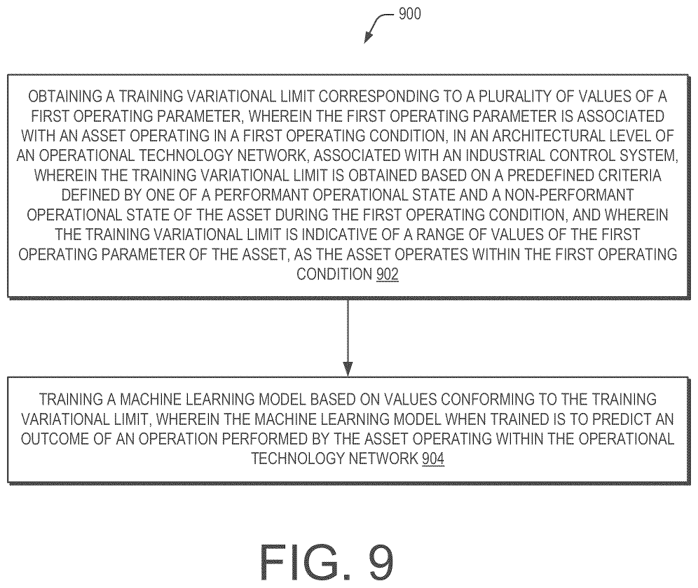

FIG. 9 illustrates example method 900 for training a machine learning model, as per an example. The order in which the above-mentioned method is described is not intended to be construed as a limitation, and some of the described method blocks may be combined in a different order to implement the methods, or alternative methods.

Furthermore, the above-mentioned method 900 may be implemented in suitable hardware, computer-readable instructions, or combination thereof. The steps of such methods may be performed by either a system under the instruction of machine executable instructions stored on a non-transitory computer readable medium or by dedicated hardware circuits, microcontrollers, or logic circuits. For example, the method may be performed by a training system, such as system 502. In an implementation, the method may be performed under an “as a service” delivery model, where the control system 502, operated by a provider, receives programmable code. Herein, some examples are also intended to cover non-transitory computer readable medium, for example, digital data storage media, which are computer readable and encode computer-executable instructions, where said instructions perform some or all the steps of the above-mentioned methods.

In an example, the method 900 may be implemented by the system 502 for training the prediction model 610 based on a training data, such as variational limit(s) 326.

At block 902, training data including a training variational limit(s) 612 is obtained. In an example, the training variational limit(s) 612 comprises data pertaining to a plurality of values of an operating parameter of an asset, such as the asset(s) 208. For example, the system 502 may obtain the variational limit(s) 326 from the repository 324 and data included in the variational limit(s) 326 may be further stored as variational limit(s) 326 in the system 502. The variational limit(s) 326 may pertain to data about a plurality of asset(s) operating across multiple architectural levels of an industrial control system, such as the industrial control system 202. The training variational limit(s) 612 may be indicative of a range of values of a first operating parameter of the asset(s) 208, as the asset(s) 208 operates during a first operating condition.

For determining the training variational limit(s) 612, the system 502 may obtain values of multiple operating parameters (for example, first operating parameter, second operating parameter, and so on) of the asset(s) 208. For example, the operating parameter(s) may be obtained from asset(s) 208, including, but not limited to, any machinery, vehicles, or equipment that is used in a commercial or industrial facility or organization. The multiple operating parameter(s) may be processed based on a predefined criteria associated with the asset(s) 208. The predefined criteria may pertain to one of a performant operational state and a non-performant operational state of the asset(s) 208. In one example, the predefined criteria includes one of a threshold value for the first operating parameter, a rate of change limit for the first operating parameter and a duration for the first operating parameter to remain operational within a time-interval.

At block 904, a prediction model is trained. The prediction model 610 may be trained over a period of time. For instance, training variational limit(s) 612 of the plurality of asset(s) 208 may be continuously monitored to predict an outcome of an operation performed by the asset(s) 208, operating within the OTN 206. The prediction model 610 when trained may be utilized to determine prospective operational results of the asset(s) 208, operating within the OTN 206. For example, current operational data of the asset(s) 208 operating within the OTN 206 may be received, which may include multiple operating parameter(s) 320 of the asset(s) 208. The prediction model 610 once trained, may be implemented to identify a comparison between current values of the operating parameter(s) 320, against the respective variational limit(s) 326, and identify if any operating parameter(s) 320 is deviating from expected operational range(s).

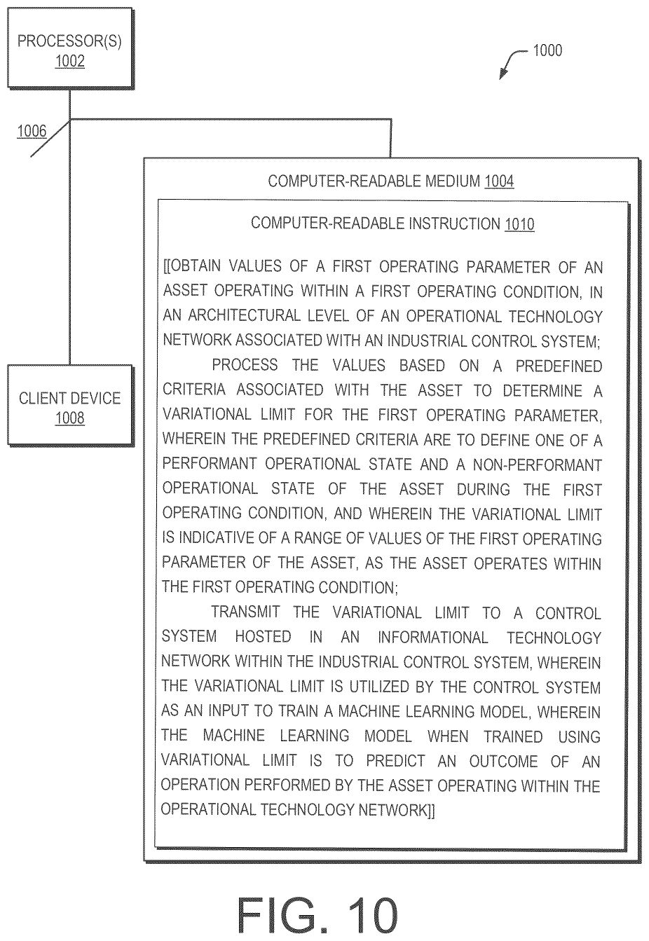

FIG. 10 illustrates a computing environment 1000 implementing a non-transitory computer readable medium for determining a variational limit(s) of an operating parameter of an asset, in response to a set of operating parameters values observed in relation to an operational component over a period of time. In an example, the computing environment 1000 includes processor(s) 1002 communicatively coupled to a non-transitory computer readable medium 1004 through a communication link 1006. In an example implementation, the computing environment 1000 may be for example, the system 102. In an example, the processor(s) 1002 may have one or more processing resources for fetching and executing computer-readable instructions from the non-transitory computer readable medium 1004. The processor(s) 1002 and the non-transitory computer readable medium 1004 may be implemented, for example, in system 502 (as has been described in conjunction with the preceding figures).

The non-transitory computer readable medium 1004 may be, for example, an internal memory device or an external memory device. In an example implementation, the communication link 1006 may be a network communication link. The processor(s) 1002 and the non-transitory computer readable medium 1004 may also be communicatively coupled to a computing device 1008 over the network.

In an example implementation, the non-transitory computer readable medium 1004 includes a set of computer readable instructions 1010 (referred to as instructions 1010) which may be accessed by the processor(s) 1002 through the communication link 1006. Referring to FIG. 10, in an example, the non-transitory computer readable medium 1004 includes instructions 1010 that cause the processor(s) 1002 to perform operations for a variational limit(s) of an asset, operating in an architectural level of an operational technology network associated with an industrial control system, such as the operational technology network (as shown in FIG. 2). The instructions 1010 may be executed to obtain values of a first operating parameter of an asset(s) operating within a first operating condition. The asset(s) may be operating in an architectural level of an operational technology network (OTN), associated with an industrial control system (ICS). In one example, the asset(s) may include, but is not be limited to, one of a machinery, equipment, and infrastructure components operating within an industrial process executing in the OTN of the ICS. In one example, the first operating parameter may, but is not limited to, one of a temperature, pressure, duty cycle, and load capacity of the asset(s) operating during an industrial process.

Once the values of the first operating parameter are obtained, the instructions 1010 may cause the processor(s) 1002 to process the values based on a predefined criteria associated with the asset. The predefined criteria may pertain to one of a performant operational state and a non-performant operational state of the asset. The values of the first operating parameter are processed to determine a variational limit(s) for the first operating parameter. In on example, the variational limit(s) may be indicative of a range of values of the first operating parameter of the asset, as the asset(s) operated within the first operating condition.

Once the variational limit(s) is determined, the instructions 1010 may cause the processor(s) 1002 to transmit the variational limit(s) to a control system. The control system may be hosted in an informational technology network within the ICS. In one example, the variational limit(s) may be utilized by the control system as an input train a machine learning model. In one example, the machine learning model when trained may predict, using the variational limit, an outcome of an operational performed by the asset(s) operating within the OTN.

Although examples for the present disclosure have been described in language specific to structural features and/or methods, it is to be understood that the appended claims are not necessarily limited to the specific features or methods described. Rather, the specific features and methods are disclosed and explained as examples of the present disclosure.

1. A system comprising:
a processor; and
a machine-readable storage medium comprising instructions executable by the processor to:
obtain values of a first operating parameter of an asset(s) operating within a first operating condition, in an architectural level of an operational technology network associated with an industrial control system;
process the values based on a predefined criteria associated with the asset(s) to determine a variational limit(s) for the first operating parameter, wherein the predefined criteria are to define one of a performant operational state and a non-performant operational state of the asset(s) during the first operating condition, and wherein the variational limit(s) is indicative of a range of values of the first operating parameter of the asset, as the asset(s) operates within the first operating condition; and
transmit the variational limit(s) to a control system hosted in an informational technology network within the industrial control system, wherein the variational limit(s) is utilized by the control system as an input to train a machine learning model, wherein the machine learning model when trained using variational limit(s) is to predict an outcome of an operation performed by the asset(s) operating within the operational technology network.

2. The system as claimed in claim 1, wherein the instructions are executable by the processor for determining the variational limit(s) to:
obtain a statistical measure of the obtained values of the first operating parameter, wherein the statistical measure includes one or more of a mean, a median, a standard deviation, and an interquartile range; and
determine an upper bound and a lower bound for the variational limit(s) based on determined statistical measure.

3. The system as claimed in claim 1, wherein the predefined criteria comprise one of a threshold value for the first operating parameter, a rate of change limit for the first operating parameter and a duration for the first operating parameter to remain operational within a time-interval.

4. The system as claimed in claim 1, wherein the instructions are executable by the processor to:
obtain values of a second operating parameter of the asset(s) in a second operating condition; and
obtain, based on the processing of the values, a trend of values of each of the first operating parameter and the second operating parameter, wherein the trend is one of pattern and direction of change observed in the values of the first and the second operating parameters.

5. The system of claim 4, wherein the trend comprises one of temporal trends and non-temporal trends between values of operating parameters, wherein the temporal trends comprise a short-term fluctuation, long-term trend, cyclic trend, seasonal variations, sudden spikes, sudden drops, periods of stability, rate of change over different time scales, and moving averages and the non-temporal trends comprises linear correlation, inverse relation, non-linear correlation, hysteresis relation, oscillatory relation, ratio relation, lag relation, conditional relation, and threshold relation.

6. The system as claimed in claim 1, wherein the instructions are further executable by the processor to:
determine a performance indicator value of the asset(s) based on the variational limit;
associate the performance indicator value of the asset(s) with an operational recommendation, wherein the operational recommendation defines an optimization to be applied to the asset(s) to adjust performance of the asset; and
transmit the operational recommendation to the control system for training the machine learning model.

7. The system as claimed in claim 1, wherein the asset(s) is one of a machinery, equipment, and infrastructure components operating within an industrial process executing in the operational technology network of the industrial control system.

8. The system as claimed in claim 1, wherein the first operating parameter and second operating parameter is one of a temperature, pressure, duty cycle, and load capacity of the asset(s) operating during industrial process.

9. A method comprising:
obtaining a training variational limit(s) corresponding to a plurality of values of a first operating parameter,
wherein the first operating parameter is associated with an asset(s) operating in a first operating condition, in an architectural level of an operational technology network, associated with an industrial control system,
wherein the training variational limit(s) is obtained based on a predefined criteria defined by one of a performant operational state and a non-performant operational state of the asset(s) during the first operating condition,
and wherein the training variational limit(s) is indicative of a range of values of the first operating parameter of the asset, as the asset(s) operates within the first operating condition; and
training a machine learning model based on values conforming to the training variational limit(s), wherein the machine learning model when trained is to predict an outcome of an operation performed by the asset(s) operating within the operational technology network.

10. The method as claimed in claim 9, wherein the asset(s) is one of a machinery, equipment, and infrastructure components operating within an industrial process executing in the operational technology network of the industrial control system.

11. The method as claimed in claim 9, wherein the predefined criteria comprises one of a threshold value for the first operating parameter, a rate of change limit for the first operating parameter and a duration for the first operating parameter to remain operational within a specific range.

12. The method as claimed in claim 9, comprising
obtaining values of a second operating parameter of the asset(s) in a second operating condition; and
training the machine learning model, wherein the machine learning model when trained is to obtain a trend in the values of each of the first operating parameter and the second operating parameter, wherein the trend is one of pattern and direction of change observed in the values of first and second operating parameters.

13. The method as claimed in claim 9, wherein trend comprises one of temporal trends and non-temporal trends between values of operating parameters, wherein the temporal trends comprise a short-term fluctuation, long-term trend, cyclic trend, seasonal variations, sudden spikes, sudden drops, periods of stability, rate of change over different time scales, and moving averages and the non-temporal trends comprises linear correlation, inverse relation, non-linear correlation, hysteresis relation, oscillatory relation, ratio relation, lag relation, conditional relation, and threshold relation.

14. A non-transitory computer-readable medium comprising instructions, the instructions being executable by a processing resource to:
obtain values of a first operating parameter of an asset(s) operating within a first operating condition, in an architectural level of an operational technology network associated with an industrial control system;
process the values based on a predefined criteria associated with the asset(s) to determine a variational limit(s) for the first operating parameter, wherein the predefined criteria are to define one of a performant operational state and a non-performant operational state of the asset(s) during the first operating condition, and wherein the variational limit(s) is indicative of a range of values of the first operating parameter of the asset, as the asset(s) operates within the first operating condition; and
transmit the variational limit(s) to a control system hosted in an informational technology network within the industrial control system, wherein the variational limit(s) is utilized by the control system as an input to train a machine learning model, wherein the machine learning model when trained using the variational limit(s) is to predict an outcome of an operation performed by the asset(s) operating within the operational technology network.

15. The non-transitory computer-readable medium as claimed in claim 14, wherein the instructions are executable by the processing resource to:
obtain a statistical measure of the values of the first operating parameter, wherein the statistical measure includes one or more of mean, median, standard deviation, and interquartile range; and
determine an upper bound and a lower bound for the variational limit(s) based on determined statistical measure.

16. The non-transitory computer-readable medium as claimed in claim 14, wherein the instructions are further executable by the processing resource to:
obtain values of a second operating parameter of the asset(s) in a second operating condition; and
obtain, based on the processing of the values, a trend of values of each of the first operating parameter and the second operating parameter, wherein the trend is one of pattern and direction of change observed in the values of the first and the second operating parameters.

17. The non-transitory computer-readable medium as claimed in claim 16, wherein the trend comprises one of temporal trends and non-temporal trends between values of operating parameters, wherein the temporal trends comprise a short-term fluctuation, long-term trend, cyclic trend, seasonal variations, sudden spikes, sudden drops, periods of stability, rate of change over different time scales, and moving averages and the non-temporal trends comprises linear correlation, inverse relation, non-linear correlation, hysteresis relation, oscillatory relation, ratio relation, lag relation, conditional relation, and threshold relation

18. The non-transitory computer-readable medium as claimed in claim 14, wherein the instructions are executable by the processing resource to:
determine a performance indicator value of the asset(s) based on the variational limit;
associate the performance indicator value of the asset(s) with an operational recommendation, wherein the operational recommendation defines an optimization to be applied to the asset(s) to adjust performance of the asset; and
transmit the operational recommendation to the control system for training the machine learning model.

19. The non-transitory computer-readable medium as claimed in claim 14, wherein the first operating parameter and second operating parameter is one of a temperature, pressure, duty cycle, and load capacity of the asset(s) operating during industrial process.

20. The non-transitory computer-readable medium as claimed in claim 14, wherein the predefined criteria comprise one of a threshold value for the first operating parameter, a rate of change limit for the first operating parameter and a duration for the first operating parameter to remain operational within a specific range.
